(19) United States
(12) Patent Application Publication
(10) Pub. No.: US 2003/0192034 A1
(43) Pub. Date: Oct. 9, 2003

(54) Trace device preventing loss of trace information which will be important in debugging

(75) Inventor: Kiyoshi Hayase, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 10/309,171

(22) Filed: Dec. 4, 2002

(30) Foreign Application Priority Data
Apr. 4, 2002 (JP) 2002-102526(P)

(51) Int. Cl. G06F 9/44

(52) U.S. Cl. 717/128

(57) ABSTRACT

A comparator generates an event A when a value of a PC of a CPU matches a target address set in a target address register. If a trace is performed in a real-time trace mode in the initial state, an RS-FF is set by the generation of the event A and the trace will be performed in a full trace mode. Therefore, by setting a starting address of a subroutine for debugging in the target address register, the trace mode will be changed to the full trace mode when the CPU executes the subroutine, and thereby loss of trace information which will be important in debugging software can be prevented.

### BACKGROUND OF THE INVENTION

1. Field of the Invention

The present invention relates to a technique of generating trace information of a CPU (Central Processing Unit) used for debugging hardware having the CPU and for debugging software and, more specifically, to a trace device preventing loss of trace information which will be important in debugging.

2. Description of the Background Art

In recent years, CPUs are widely used in information equipment such as personal computer, home appliances and the like. It is important to analyze flow of a program executed by a CPU in development of the CPU itself, as well as in development of information equipment, home appliances or the like which is provided with such CPU. One of the methods enabling such analysis is to provide a trace function inside a semiconductor chip to transmit operations of the CPU to the outside of the semiconductor chip having the CPU.

On the other hand, there is also a need to enhance the processing speed of a CPU, and an operation frequency of a CPU is correspondingly becoming higher, so that the frequency is becoming much higher than that of the circuits outside the CPU. As a result, the operation of the outside circuit cannot follow the speed of the trace output, and various contrivances have been made to the trace function.

One of conventional trace devices has a break pointer for beginning the trace and a break pointer for ending the trace, and the trace is started when a value of a program counter of a CPU (hereinafter referred to as a PC value) matches a value of the break pointer for beginning the trace, and the trace is ended when the PC value of the CPU matches a value of the break pointer for ending the trace.

In addition, a conventional trace device performs a full trace or a real-time trace. The full trace is to output all of the trace information of the CPU, and therefore the trace output is performed while stalling the CPU. On the other hand, the real-time trace permits loss of a part of the trace information of the CPU, and therefore the trace output is performed while not stalling the CPU.

In the above-mentioned conventional trace device, as the trace is started when the PC value of the CPU matches the value of the break pointer for beginning the trace and is ended when the PC value of the CPU matches the value of the break pointer for ending the trace, the trace information between the time when the CPU started the execution of the program and the time when the PC value of the CPU matches the value of the break pointer for beginning the trace, and the trace information after the PC value of the CPU matches the value of the break pointer for ending the trace would not be output. As a result, if the CPU operates in an unexpected manner due to a bug of software when the trace is not output, this operation will not be found early so that the debugging of the software will be difficult.

In addition, as the full trace operates the CPU while stalling the same, a bug may not be reproduced because the operation of the CPU is different from a normal operation, and therefore the debugging will be unsuccessful. Furthermore, though the real-time trace operates the CPU in a normal manner, as most of the trace information is lost due to an overflow of a trace buffer, the analysis of the bug of the software will be difficult.

The traces include a branch trace which outputs a branch destination address every time the CPU executes a branch instruction, a data trace which outputs data accessed by the CPU, and a mixed trace which outputs both the branch destination address and the data. As the mixed trace has large trace information, the operation speed of the CPU will further be decreased when the full trace is selected, and further trace information will be lost when the real-time trace is selected.

### SUMMARY OF THE INVENTION

An object of the present invention is to provide a trace device preventing loss of trace information which will be important in debugging software.

Another object of the present invention is to provide a trace device which enables debugging of software with minimal loss of trace information.

A further object of the present invention is to provide a trace device which allows a CPU to execute a program in a condition similar to that of the normal operation of the CPU even when the trace is performed in a full trace mode.

According to one aspect of the present invention, a trace device generates trace information by switching between a full trace mode to generate trace information while stalling a processor, and a real-time trace mode to generate trace information while not stalling the processor. The trace device includes an event unit generating an event when a predetermined condition is met, and a trace unit detecting the generation of the event and generating the trace information by switching between the full trace mode and the real-time trace mode.

As the trace unit detects the generation of the event and generates the trace information by switching between the full trace mode and the real-time trace mode, the trace device can operate in the full trace mode when an operation of a processor is to be analyzed in detail, and can operate in the real-time trace mode when the detailed analysis is unnecessary. Therefore, loss of the trace information which will be important in debugging software can be prevented. In addition, as the trace is performed in the real-time trace mode when the detailed analysis of the operation of the processor is unnecessary, the CPU can operate in a condition similar to that of the normal operation of the CPU.

According to another aspect of the present invention, a trace device generates trace information of a processor by switching a trace mode to one of a branch trace mode, a data trace mode, and a mixed trace mode. The trace device includes an event unit generating an event when a predetermined condition is met, and a trace unit detecting the generation of the event and generating the trace information by switching of the branch trace mode, data trace mode and mixed trace mode.

As the trace unit detects the generation of the event and generates the trace information by switching of the branch trace mode, data trace mode and mixed trace mode, the type of the trace information can be changed when an operation of a processor is to be analyzed in detail, and when the detailed analysis is unnecessary. Therefore, as an amount of the trace information can be reduced in the branch trace mode or the data trace mode, time for stalling the processor can be minimized and the debugging of the software can be performed in a condition similar to that of the normal operation of the processor.

According to further aspect of the present invention, a trace device to generate and output trace information of a processor includes an event unit generating an event when a predetermined condition is met, and a trace unit detecting the generation of the event and generating the trace information after determining whether to generate the trace information in an absolute address or in a relative address.

As the trace unit detects the generation of the event and generates the trace information after determining whether to generate the trace information in the absolute address or in the relative address, an amount of the trace information can be reduced when the trace information is generated in the relative address. Therefore, a time for stalling the processor can be minimized when the trace is performed in the full trace mode, and the debugging of the software can be performed in a condition similar to that of the normal operation of the processor. In addition, loss of the trace information can be minimized when the trace is performed in the real-time trace mode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1-10 are block diagrams showing schematic structures of semiconductor devices respectively having trace devices in first to tenth embodiments of the present invention.

### DESCRIPTION OF THE PREFERRED EMBODIMENTS

(First Embodiment)

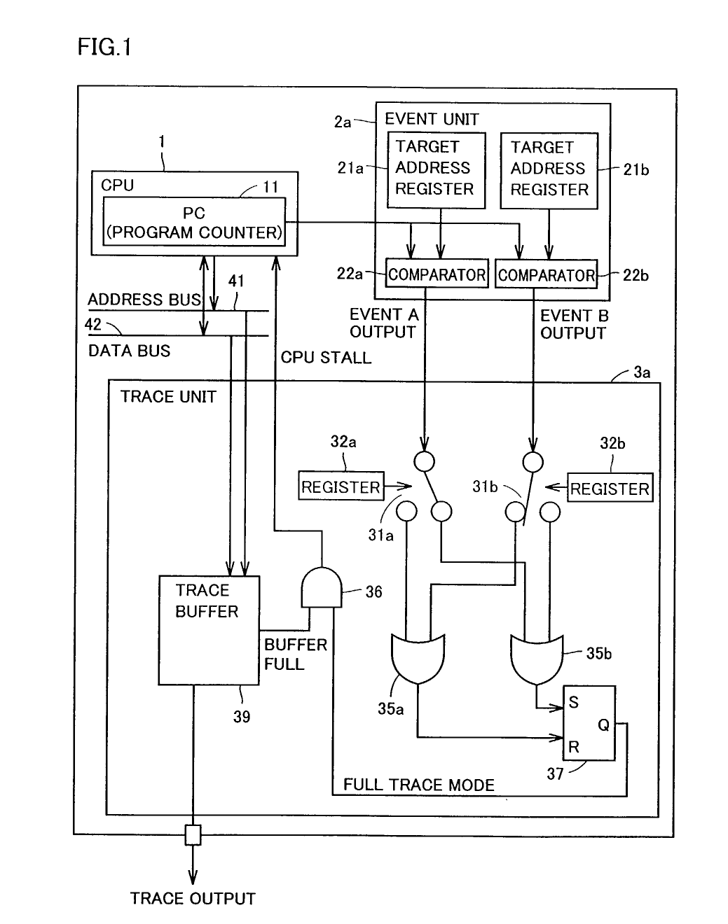

FIG. 1 is a block diagram showing a schematic structure of a semiconductor device having a trace device in a first embodiment of the present invention. The semiconductor device includes a CPU 1, an event unit 2a, and a trace unit 3a. Hereinafter, event unit 2a and trace unit 3a are referred to as a trace device as a whole.

Event unit 2a includes target address registers 21a and 21b wherein target addresses are set, a comparator 22a to compare a value of a PC 11 of CPU 1 with the target address held in target address register 21a, and a comparator 22b to compare the value of PC 11 of CPU 1 with the target address held in target address register 21b. Target address registers 21a and 21b are accessible by CPU 1.

Comparator 22a compares the PC value of CPU 1 with the target address set in target address register 21a, and outputs the low level (referred to as the “L level” hereinafter) when they mismatch, and outputs the high level (referred to as the “H level” hereinafter) when they match to notify trace unit 3a of a generation of an event A. Similarly, comparator 22b compares the PC value of CPU 1 with the target address set in target address register 21b, and outputs the L level when they mismatch, and outputs the H level when they match to notify trace unit 3a of a generation of an event B.

Trace unit 3a includes switches 31a and 31b, a register 32a wherein a value for switching switch 31a is set, a register 32b wherein a value for switching switch 31b is set, OR gates 35a and 35b, an AND gate 36, an RS-flip-flop (referred to as an RS-FF hereinafter) 37, and a trace buffer 39. Herein, registers 32a and 32b are accessible by CPU 1.

In a branch trace mode, trace buffer 39 successively receives a branch address output to an address bus 41, generates a packet including the branch address, and outputs the same from a trace output terminal. In a data trace mode, trace buffer 39 successively receives an operand access data output to a data bus 42, generates a packet including the operand access data, and outputs the same from the trace output terminal. In a mixed trace mode, trace buffer 39 successively receives the branch address output to address bus 41 and the operand access data output to data bus 42, generates a packet including the branch address or the operand access data, and outputs the same from the trace output terminal.

Trace buffer 39 outputs the trace information to the outside by outputting a packet of 8 bits several times from the trace output terminal. In the branch trace mode, trace buffer 39 outputs from the trace output terminal the branch trace information of 6 bytes (6 packets) in total, that is, identification information (4 bits), the branch address (4 bytes), and the number of instructions executed between the last branch instruction and the present branch instruction (12 bits).

In the data trace mode, trace buffer 39 outputs from the trace output terminal the data trace information of 9 bytes (9 packets) in total, that is, the identification information (1 byte), the operand access data (4 bytes), and the address (4 bytes).

In the mixed trace mode, trace buffer 39 selectively outputs the above-mentioned branch trace information of 6 bytes and data trace information of 9 bytes from the trace output terminal. It is to be noted that, since the instruction executing speed of CPU 1 is much higher than the output speed of trace buffer 39 generating the trace information and outputting the same from the trace output terminal by 8 bits, trace buffer 39 will enter a buffer-full state. In such a condition, trace buffer 39 outputs a buffer-full signal of the H level.

In register 32a, a value is set indicating whether the trace device will operate in the full trace mode or in the real-time trace mode when the event A is generated. Similarly, in register 32b, a value is set indicating whether the trace device will operate in the full trace mode or in the real-time trace mode when the event B is generated.

When switches 31a and 31b are connected as shown in FIG. 1 with the values set in registers 32a and 32b, for example, if the event A is generated, OR gate 35b outputs the H level and RS-FF 37 is set to output a full trace mode signal of the H level. As a result, when trace buffer 39 enters the buffer-full state (the buffer-full signal is at the H level), AND gate 36 outputs a CPU stall signal of the H level and stalls CPU 1. That is, the trace is performed in the full trace mode. The buffer-full signal is set to the L level when there is any available space in trace buffer 39, and then the execution of instructions by CPU 1 is resumed.

When the event B is generated, OR gate 35a outputs the H level, and RS-FF 37 is reset to output the full trace mode signal of the L level. As a result, AND gate 36 outputs the CPU stall signal of the L level and does not stall CPU 1. That is, the trace is performed in the real-time trace mode. In this condition, as the output signal of AND gate 36 remains at the L level and CPU 1 is not stalled even when trace buffer 39 enters the buffer-full state and the buffer-full signal is set to the H level, the trace information is overwritten and the old trace information is lost.

When switches 31a and 31b are connected to the respective opposite terminals with the values set in registers 32a and 32b, the trace is performed in the real-time trace mode by the generation of the event A, and in the full trace mode by the generation of the event B.

When a subroutine on software probably having a bug can be predicted, the starting address of the subroutine is set in target address register 21a, and the last address of the subroutine is set in target address register 21b. Then, by setting switches 31a and 31b as shown in FIG. 1 with the values in registers 32a and 32b, the trace is performed in the full trace mode while CPU 1 is executing the subroutine to prevent loss of the trace information. The trace can be performed in the real-time trace mode in the other periods to allow loss of the trace information.

As described above, according to the trace device in the first embodiment of the present invention, the trace mode is switched when the PC value of CPU 1 matches the target addresses set in target address registers 21a and 21b. As a result, the trace is performed in different trace modes at a portion where the trace information must be analyzed in detail and at the other portions, and therefore the debugging of a subroutine or the like can easily be performed.

(Second embodiment)

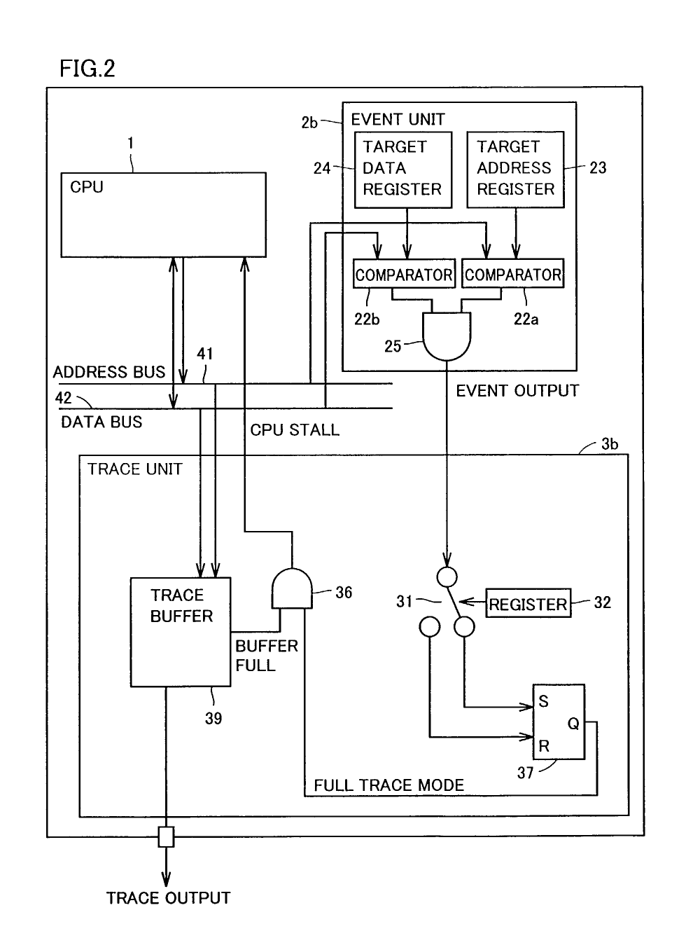

FIG. 2 is a block diagram showing a schematic structure of a semiconductor device having a trace device in a second embodiment of the present invention. The semiconductor device includes CPU 1, an event unit 2b, and a trace unit 3b. Herein, the same reference characters indicate portions having the same structure and function as the semiconductor device in the first embodiment shown in FIG. 1.

Event unit 2b includes a target address register 23 wherein a target address is set, a target data register 24 wherein target data are set, comparator 22a to compare the address value output to address bus 41 with the target address held in target address register 23, comparator 22b to compare the data output to data bus 42 with the target data held in target data register 24, and an AND gate 25. Herein, target address register 23 and target data register 24 are accessible by CPU 1.

Comparator 22a compares the address value output to address bus 41 with the target address set in target address register 23, and outputs the L level when they mismatch, and outputs the H level when they match. Comparator 22b compares the data output to data bus 42 with the target data set in target data register 24, and outputs the L level when they mismatch, and outputs the H level when they match.

When the output signals of both comparators 22a and 22b are at the H level, AND gate 25 outputs the H level to notify trace unit 3b of the generation of the event.

Trace unit 3b includes switch 31, register 32 wherein a value for switching switch 31 is set, AND gate 36, RS-FF 37, and trace buffer 39. Herein, register 32 is accessible by CPU 1.

In register 32, a value is set indicating whether the trace device operates in the full trace mode or in the real-time trace mode when the event is generated. When switch 31 is connected as shown in FIG. 2 with the value set in register 32, if the event is generated, RS-FF 37 is set and the full trace mode signal of the H level is output. As a result, when trace buffer 39 enters the buffer-full state (the buffer-full signal is set to the H level), AND gate 36 outputs the CPU stall signal of the H level and stalls CPU 1. That is, the trace is performed in the full trace mode. It is assumed that RS-FF 37 outputs the L level and CPU 1 operates in the real-time trace mode in the initial state.

When switch 31 is connected to the opposite terminal with the value set in register 32, the full trace mode will be switched to the real-time trace mode by the generation of the event.

If there is a bug in an operation to transfer data of a DMAC (Direct Memory Access Controller), for example, prescribed data of a prescribed address generated in the data transfer of the DMAC is set in target address register 23 and target data register 24. Then, by setting switch 31 as shown in FIG. 2 with the value of register 32, the trace can be performed in the full trace mode when the prescribed data of the prescribed address is accessed by the DMAC to prevent loss of the trace information. The trace is performed in the real-time trace mode in other periods, and loss of the trace information is allowed.

As described above, according to the trace device in the second embodiment of the present invention, the trace mode is switched when the address value output to address bus 41 matches the target address set in target address register 23 and the data output to data bus 42 matches the data set in target data register 24. As a result, the trace is performed in different modes at a portion where the trace information must be analyzed in detail and at the other portions, and the debugging of a portion such as a certain portion where the DMA transfer occurs can easily be performed.

(Third embodiment)

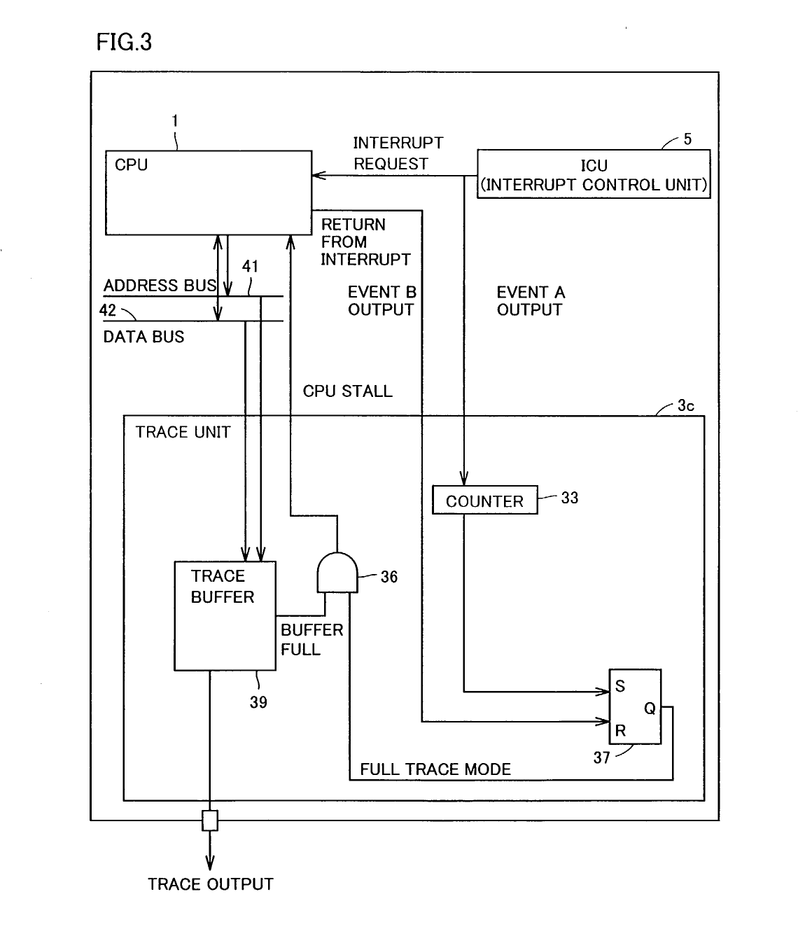

FIG. 3 is a block diagram showing a schematic structure of a semiconductor device having a trace device in a third embodiment of the present invention. The semiconductor device includes CPU 1, a trace unit 3c, and an interrupt control unit (referred to as an ICU hereinafter) 5. Herein, portions having the same structure and function as the semiconductor devices in the first and second embodiments shown in FIGS. 1 and 2 are indicated by the same reference characters.

When the prescribed cause of interrupt is generated, ICU 5 outputs an interrupt request to CPU 1, and also outputs an event A output signal of the H level to notify trace unit 3c of the generation of the event A. In addition, to return from the interrupt routine corresponding to the event A to the state before receiving the interrupt, CPU 1 outputs a return-from-interrupt signal of the H level, and notifies trace unit 3c of the end of interrupt routine (the event B).

Trace unit 3c includes a counter 33, AND gate 36, RS-FF 37, and trace buffer 39. Herein, the count value of counter 33 is changed by CPU 1.

Counter 33 counts the number of the event A output from ICU 5, and outputs the H level when the overflow occurs. At this time, RS-FF 37 is set to output the full trace mode signal of the H level. As a result, when trace buffer 39 enters the buffer-full state (the buffer-full signal is set to the H level), AND gate 36 outputs a CPU stall signal of the H level and stalls CPU 1. That is, the trace is performed in the full trace mode.

When the processing of the interrupt routine corresponding to the event A is to be ended, CPU 1 outputs the return-from-interrupt signal of the H level and resets RS-FF 37. As a result, RS-FF 37 outputs the L level, and CPU 1 operates in the real-time trace mode.

Assume that a bug is found in the second interrupt processing, for example. As the trace information of the normal processing other than the interrupt processing as well as that of the first interrupt processing may be lost, the trace can be operated while not stalling CPU 1 for such processing. By changing the trace mode to the full trace mode for the second interrupt processing, loss of the trace information thereof can be prevented. In addition, as the operation of CPU 1 just before the generation of the second interrupt processing can be analyzed to a certain degree, a bug of the software before and after the interrupt processing can be found.

As described above, according to the trace device in the third embodiment of the present invention, the trace mode is changed to the full trace mode by counting the number of the event corresponding to the prescribed cause of interrupt output from ICU 5. As a result, the bug of the software in the interrupt processing can be found when the interrupt corresponding to the event is generated for a prescribed number of times.

(Fourth embodiment)

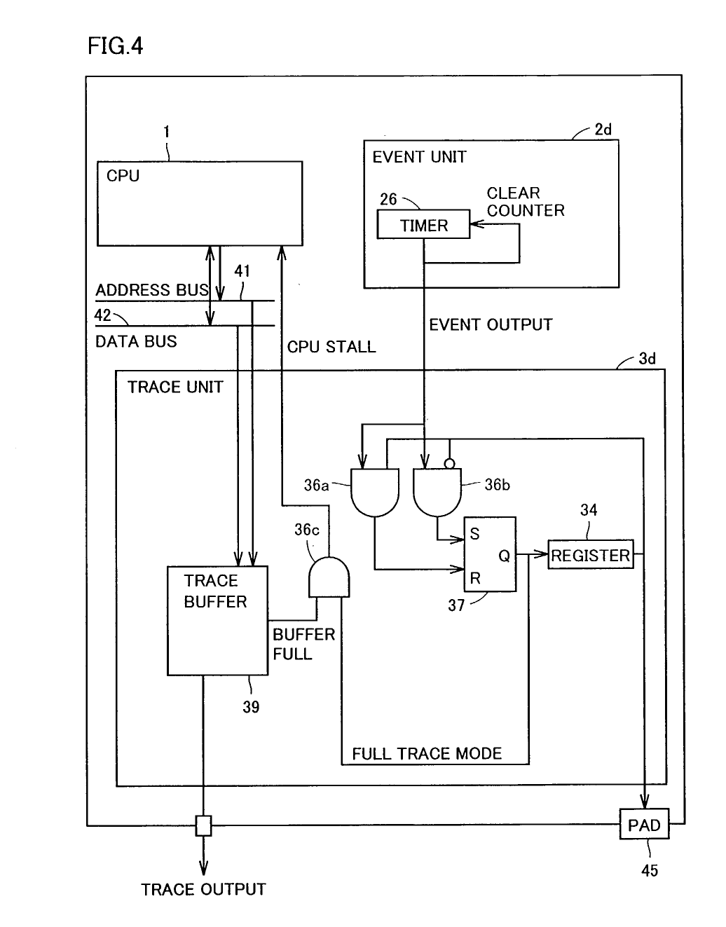

FIG. 4 is a block diagram showing a schematic structure of a semiconductor device having a trace device in a fourth embodiment of the present invention. The semiconductor device includes CPU 1, an event unit 2d and a trace unit 3d. Herein, portions having the same structure and function as the semiconductor devices in the first to third embodiments shown in FIGS. 1-3 are indicated by the same reference characters.

Event unit 2d includes a timer 26. The count number of timer 26 is set by CPU 1. When the set value is attained, timer 26 outputs an event output signal of the H level, and clears the count value of timer 26 itself.

Trace unit 3d includes a register 34, AND gates 36a-36c, RS-FF 37, and trace buffer 39. Herein, the output signal of register 34 is output to the outside of the chip via a PAD 45.

Register 34 holds a value of the output signal of RS-FF 37, that is, a value indicating whether the trace device is operating in the full trace mode or the real-time trace mode at present. When timer 26 attains the set value and the event is generated while register 34 is holding the L level (the real-time trace mode), for example, the output signal of AND gate 36b is set to the H level and RS-FF 37 is set to output the full trace mode signal of the H level. As a result, the trace mode is changed to the full trace mode, and the output signal of register 34 is set to the H level to notify the outside of the trace device operating in the full trace mode via PAD 45.

Thereafter, when timer 26 again attains the set value and outputs the event output signal of the H level, the output signal of AND gate 36a is set to the H level, and RS-FF 37 is reset to output the full trace mode signal of the L level. As a result, the trace mode is changed to the real-time trace mode, and the output signal of register 34 is set to the L level to notify the outside of the trace device operating in the real-time trace mode via PAD 45.

If there is such a bug that causes CPU 1 to hang up when a program is operated longer than a certain time period, by setting that time period to timer 26, the trace can be performed in the real-time trace mode till the certain time period has passed, and then in the full trace mode after the certain time period has passed to prevent loss of the trace information. Therefore, the operation of CPU 1 can be analyzed in detail from just before the hang-up of CPU 1.

As described above, according to the trace device in the fourth embodiment of the present invention, the trace mode is changed when a certain time period set in timer 26 has passed. As a result, when CPU 1 operates incorrectly after operating a program for longer than a certain time period, for example, the operation of CPU 1 can be analyzed in detail from just before the operation error occurs, so that the debugging can easily be performed.

(Fifth embodiment)

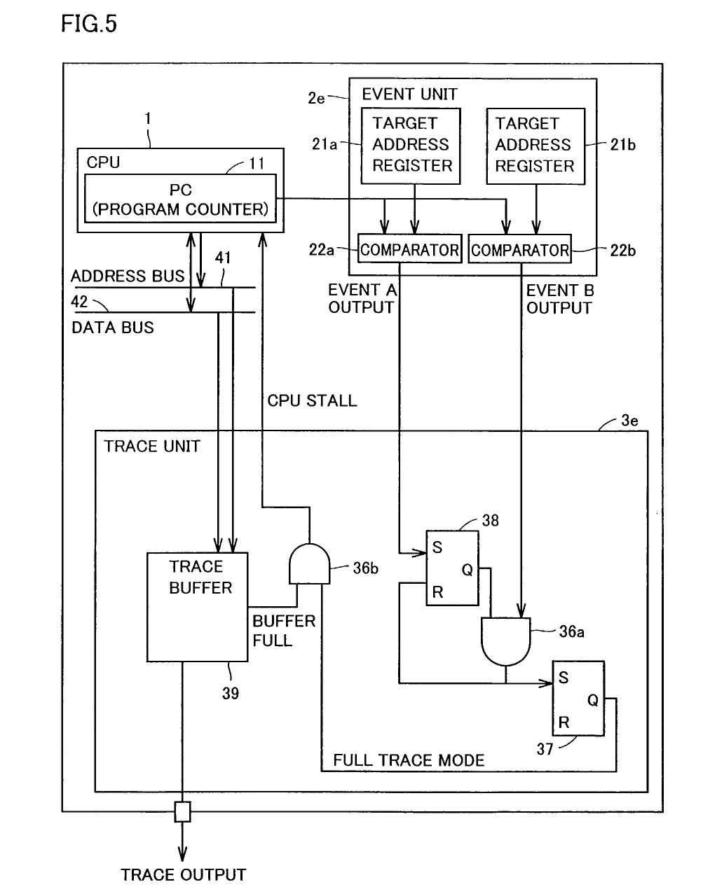

FIG. 5 is a block diagram showing a schematic structure of a semiconductor device having a trace device in a fifth embodiment of the present invention. The semiconductor device includes CPU 1, an event unit 2e and a trace unit 3e. Herein, portions having the same structure and function as the semiconductor devices in the first to fourth embodiments shown in FIGS. 1-4 are indicated by the same reference characters.

Event unit 2e includes target address registers 21a and 21b wherein target addresses are set, a comparator 22a to compare a value of PC 11 of CPU 1 with the target address held in target address register 21a, and a comparator 22b to compare the value of PC 11 of CPU 1 with the target address held in target address register 21b. Target address registers 21a and 21b are accessible by CPU 1.

Comparator 22a compares the PC value of CPU 1 with the target address set in target address register 21a, and outputs the L level when they mismatch, and outputs the H level when they match to notify trace unit 3e of a generation of the event A. Similarly, comparator 22b compares the PC value of CPU 1 with the target address set in target address register 21b, and outputs the L level when they mismatch, and outputs the H level when they match to notify trace unit 3e of a generation of the event B.

Trace unit 3e includes AND gates 36a and 36b, RS-FFs 37 and 38, and trace buffer 39. In the initial state, it is assumed that each of RS-FFs 37 and 38 outputs the output signal of the L level, and the trace device is operating in the real time trace mode.

When the event A is generated, RS-FF 38 is set to output the output signal of the H level. Thereafter, when the event B is generated, AND gate 36a outputs the output signal of the H level, and RS-FF 37 is set to output the full trace mode signal of the H level while RS-FF 38 is reset. As a result, when trace buffer 39 enters the buffer-full state (the buffer-full signal is set to the H level), AND gate 36b outputs the CPU stall signal of the H level and stalls CPU 1. That is, the trace is performed in the full trace mode. The buffer-full signal is set to the L level when there is any available space in trace buffer 39, and then the execution of instructions by CPU 1 is resumed.

Assume that CPU 1 operates incorrectly only when the subroutine B is executed after the subroutine A, and that the operation error does not occur when the subroutine B is executed before the subroutine A, for example. In such a case, with setting the starting address of the subroutine A in target address register 21a and the starting address of the subroutine B in target address register 21b, normal operation of CPU 1 is allowed as long as possible before the occurrence of the operation error of CPU 1, and by changing the trace mode to the full trace mode at the probable portion for a bug of the software, the operation of CPU 1 before and after the occurrence of the operation error can be analyzed in detail.

As described above, according to the trace device in the fifth embodiment of the present invention, the trace mode is switched only when the PC value of CPU 1 matches the target address set in target address register 21b after the PC value of CPU 1 matches the target address set in target address register 21a. As a result, software such as the one with which CPU 1 operates incorrectly only when two subroutines are processed in a certain order, can easily be debugged.

(Sixth embodiment)

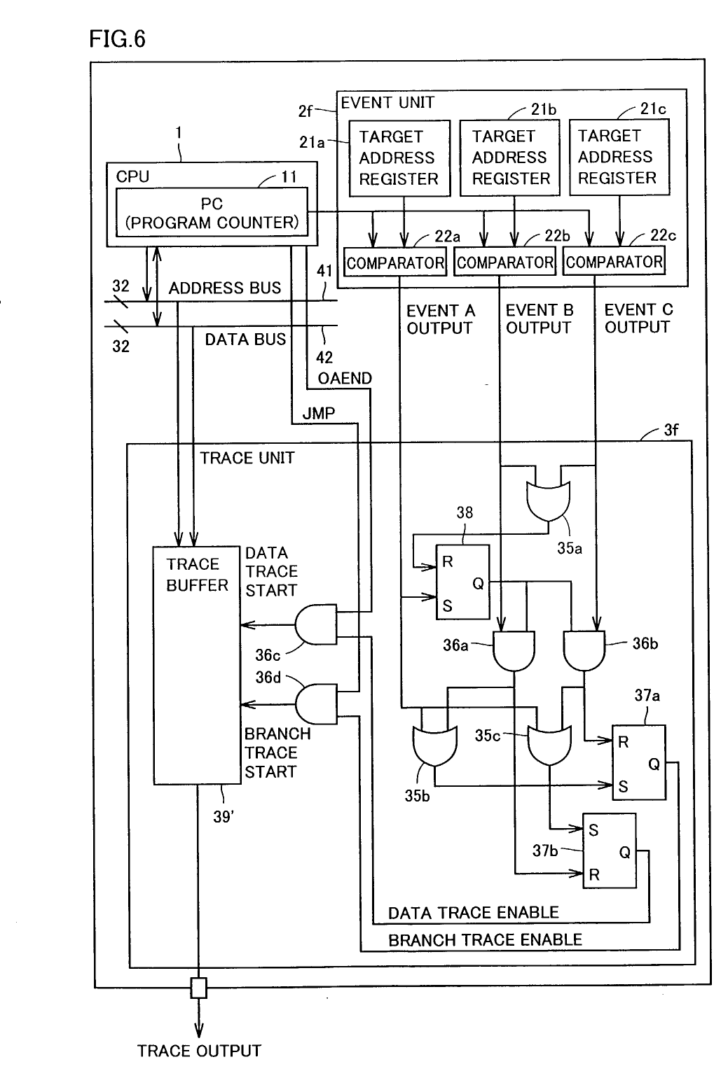

FIG. 6 is a block diagram showing a schematic structure of a semiconductor device having a trace device in a sixth embodiment of the present invention. The semiconductor device includes CPU 1, an event unit 2f and a trace unit 3f. Herein, portions having the same structure and function as the semiconductor devices in the first to fifth embodiments shown in FIGS. 1-5 are indicated by the same reference characters.

When an operand access instruction is executed (on an instruction execution stage in a pipeline processing), CPU 1 outputs an OAEND signal of the H level. In addition, when the branch instruction is executed (on an instruction execution stage in a pipeline processing), CPU 1 outputs a JMP signal of the H level.

Event unit 2f includes target address registers 21a-21c wherein target addresses are set, comparator 22a to compare a value of PC 11 of CPU 1 with the target address held in target address register 21a, comparator 22b to compare the value of PC 11 of CPU 1 with the target address held in target address register 21b, and a comparator 22c to compare the value of PC 11 of CPU 1 with the target address held in target address register 21c. Target address registers 21a-21c are accessible by CPU 1.

Comparator 22a compares the PC value of CPU 1 with the target address set in target address register 21a, and outputs the L level when they mismatch, and outputs the H level when they match to notify trace unit 3f of a generation of the event A. Similarly, comparator 22b compares the PC value of CPU 1 with the target address set in target address register 21b, and outputs the L level when they mismatch, and outputs the H level when they match to notify trace unit 3f of a generation of the event B. Similarly, comparator 22c compares the PC value of CPU 1 with the target address set in target address register 21c, and outputs the L level when they mismatch, and outputs the H level when they match to notify trace unit 3f of a generation of an event C.

Trace unit 3f includes OR gates 35a-35c, AND gates 36a-36d, RS-FFs 37a, 37b and 38, and a trace buffer 39′. It is assumed that, in the initial state, RS-FF 37a outputs the output signal of the H level while RS-FFs 37b and 38 output the output signals of the L level, and a branch trace enable signal is set to the H level (enabled) while a data trace enable signal is set to the L level (disabled).

When AND gate 36d outputs a branch trace start signal of the H level, trace buffer 39′ receives the branch address output to address bus 41, generates a packet including the branch address and outputs the same from the trace output terminal. In addition, when AND gate 36c outputs a data trace start signal of the H level, trace buffer 39′ receives the operand access data output to data bus 42, generates a packet including the operand access data and outputs the same from the trace output terminal.

In the initial state, as RS-FF 37a outputs the output signal of the H level, a packet including the branch trace information is output from trace buffer 39′ whenever CPU 1 executes the branch instruction and the JMP signal of the H level is output. On the other hand, as RS-FF 37b outputs the output signal of the L level in the initial state, the packet including the data trace information is not generated by trace buffer 39′ even when CPU 1 executes the operand access instruction and the OAEND signal of the H level is output.

As the output signal of RS-FF 38 is at the L level even if the event B or event C is generated in such condition, the output signals of AND gates 36a and 36b remain at the L level, and the output signals of RS-FFs 37a and 37b are unchanged.

When the PC value of CPU 1 matches the target address held in target address register 21a and the event A is generated, RS-FF 38 is set and the output signal of the H level is output. At the same time, since the output signals of OR gates 35b and 35c are set to the H level, the output signals of RS-FFs 37a and 37b are set to the H level. As a result, both of the branch trace enable signal and the data trace enable signal are set to the H level, and the packet including the branch trace information or the data trace information is output from trace buffer 39′ whenever CPU 1 executes the branch instruction or the operand access instruction. That is, the trace mode is changed to the mixed trace mode.

Thereafter, when the PC value of CPU 1 matches the target address held in target address register 21c and the event C is generated, the output signal of RS-FF 37b remains at the H level, while RS-FF 37a is reset and the output signal thereof is reset to the L level. As a result, the data trace enable signal is set to the H level, and the packet including the data trace information is output from trace buffer 39′ whenever CPU 1 executes the operand access instruction and the OAEND signal of the H level is output. On the other hand, as the branch trace enable signal is reset to the L level, the packet including the branch trace information is not generated by trace buffer 39′ even when CPU 1 executes the branch instruction and the JMP signal of the H level is output. That is, the trace mode is changed to the data trace mode.

As described above, according to the trace device in the sixth embodiment of the present invention, the trace mode is changed to one of the branch trace mode, data trace mode and mixed trace mode when the PC value of CPU 1 matches one of the target addresses set in target address registers 21a-21c. As a result, the kind of trace information necessary for debugging the program can be changed for every subroutine, and the time for stalling CPU 1 can be minimized, therefore the debugging can be performed in a condition similar to that of the normal operation of CPU 1.

(Seventh embodiment)

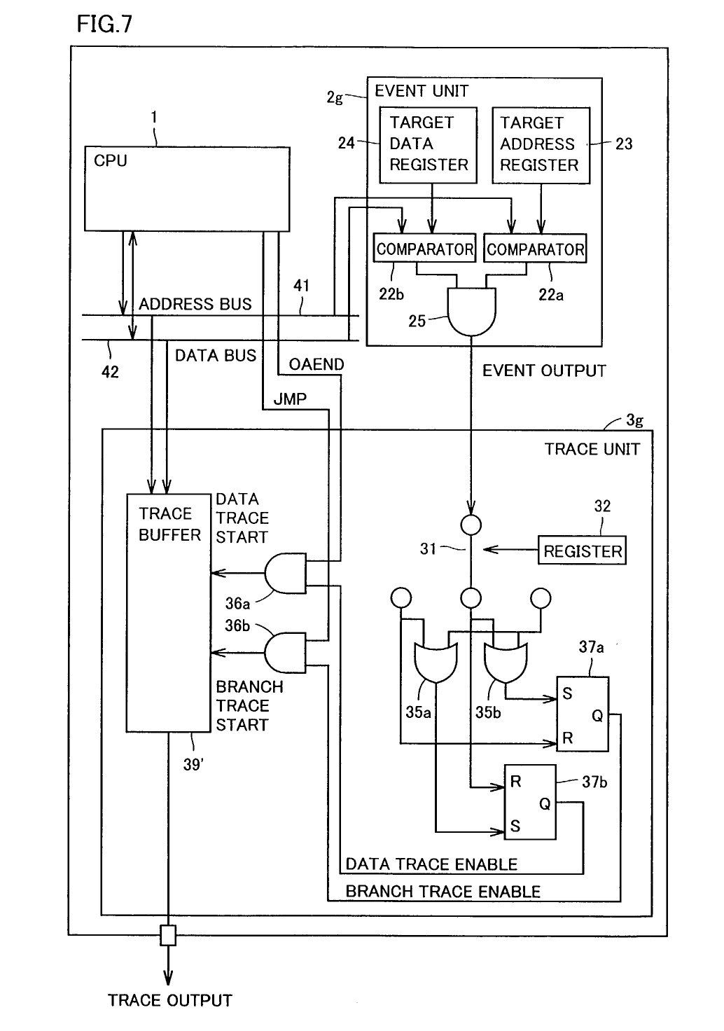

FIG. 7 is a block diagram showing a schematic structure of a semiconductor device having a trace device in a seventh embodiment of the present invention. The semiconductor device includes CPU 1, an event unit 2g and a trace unit 3g. Herein, portions having the same structure and function as the semiconductor devices in the first to sixth embodiments shown in FIGS. 1-6 are indicated by the same reference characters.

Event unit 2g includes target address register 23 wherein a target address is set, and target data register 24 wherein target data are set, comparator 22a to compare the address value output to address bus 41 with the target address held in target address register 23, comparator 22b to compare the data output to data bus 42 with the target data held in target data register 24, and AND gate 25. Herein, target address register 23 and target data register 24 are accessible by CPU 1.

Comparator 22a compares the address value output to address bus 41 with the target address set in target address register 23, and outputs the L level when they mismatch, and outputs the H level when they match. Comparator 22b compares the data output to data bus 42 with the target data set in target data register 24, and outputs the L level when they mismatch, and outputs the H level when they match.

When the output signals of both comparators 22a and 22b are at the H level, AND gate 25 outputs the H level to notify trace unit 3g of the generation of the event.

Trace unit 3g includes switch 31, register 32 wherein a value for switching switch 31 is set, OR gates 35a and 35b, AND gates 36a and 36b, RS-FFs 37a and 37b, and trace buffer 39′. Herein, register 32 is accessible by CPU 1.

A value of 2 bits is set in register 32, indicating if the trace device will operate in the branch trace mode, data trace mode or mixed trace mode when the event is generated. If the event is generated when switch 31 is connected as shown in FIG. 7 with the value set in register 32, for example, RS-FF 37a is set and RS-FF 37b is reset, and the branch trace enable signal of the H level is output, while the data trace enable signal of the L level is output.

As a result, the packet including the branch trace information is output from trace buffer 39′ whenever CPU 1 executes the branch instruction and the JMP signal of the H level is output. In addition, the packet including the data trace information is not generated by trace buffer 39′ even if CPU 1 executes the operand access instruction and the OAEND signal of the H level is output, because the output signal of AND gate 36a remains at the L level. That is, the trace device operates in the branch trace mode.

When switch 31 is connected to the left terminal with the value set in register 32, the trace mode is changed to the data trace mode by the generation of the event. When switch 31 is connected to the right terminal with the value set in register 32, the trace mode is changed to the mixed trace mode by the generation of the event.

Assume that CPU 1 is known to hang up after writing a certain data into a certain address, for example. In such a case, with setting the certain address and data in target address register 23 and target data register 24, it is possible to analyze, for example, the address to which CPU 1 was branching, or the operand which is accessed by CPU 1 just before the hang-up, whereby the debugging of the software can easily be performed.

It is to be noted that, the output signal of AND gate 36a may be used as the event output signal, and the branch trace enable signal or the data trace enable signal may be switched if the event B is generated after the event A, as the trace device in the fifth embodiment shown in FIG. 5.

As described above, according to the trace device in the seventh embodiment of the present invention, the trace mode is switched when the address value output to address bus 41 matches the target address set in target address register 23 and the data output to data bus 42 matches the data set in target data register 24. As a result, the kind of trace information output from trace buffer 39′ can be changed corresponding to the condition of the bug, and the debugging of the software can easily be performed.

(Eighth embodiment)

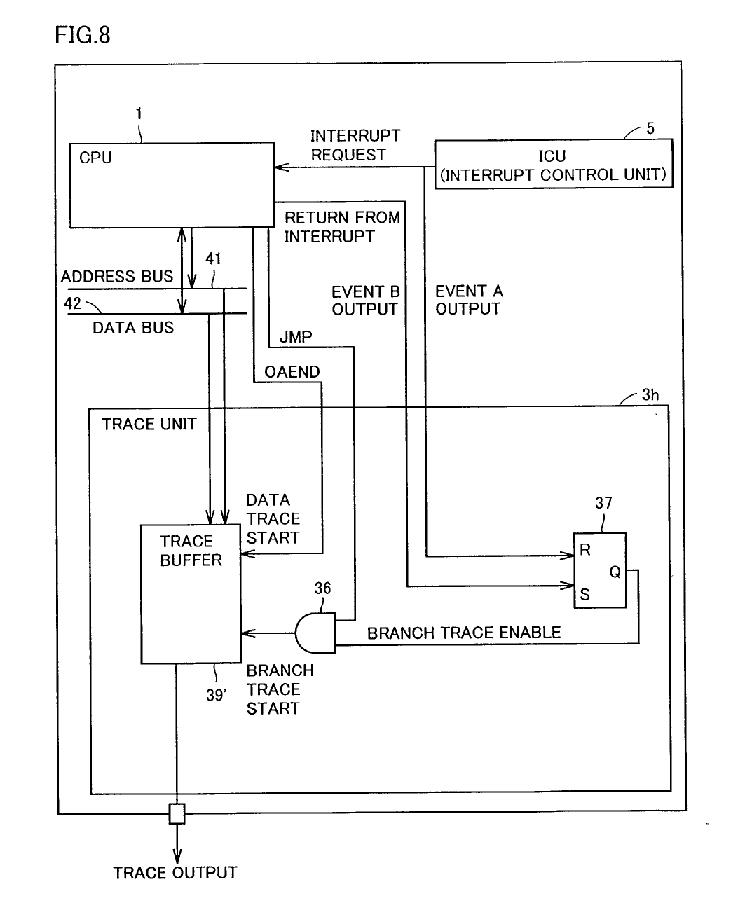

FIG. 8 is a block diagram showing a schematic structure of a semiconductor device having a trace device in an eighth embodiment of the present invention. The semiconductor device includes CPU 1, a trace unit 3h and ICU 5. Herein, portions having the same structure and function as the semiconductor devices in the first to seventh embodiments shown in FIGS. 1-7 are indicated by the same reference characters.

Trace unit 3h includes AND gate 36, RS-FF 37 and trace buffer 39′. It is assumed that the output signal of RS-FF 37 of the H level is output in the initial state.

In the initial state, if CPU 1 executes the branch instruction and outputs the JMP signal of the H level, AND gate 36 outputs the branch trace start signal of the H level, because the branch trace enable signal of the H level is output. As a result, the packet including the branch trace information is output from trace buffer 39′. In addition, when CPU 1 executes the operand access instruction and the OAEND signal is set to the H level, the packet including the data trace information is output from trace buffer 39′ regardless of the output signal of RS-FF 37. That is, the trace device operates in the mixed trace mode.

In addition, when ICU 5 outputs the event A output signal of the H level, the output signal of RS-FF3 of the L level is output. As a result, the packet including the branch trace information is not generated by trace buffer 39′, because the branch trace start signal remains at the L level even when CPU 1 executes the branch instruction and the JMP signal of the H level is output. That is, the trace device is operated in the data trace mode.

Furthermore, when the processing of the interrupt routine corresponding to the event A is ended, CPU 1 outputs the return-from-interrupt signal (an event B output signal) of the H level and sets RS-FF 37. As a result, RS-FF 37 outputs the H level, and CPU 1 operates in the mixed trace mode.

Though the branch trace information is needed in the normal processing other than the interrupt processing because the flow of the processing of the program must be analyzed, as most of the operations in the interrupt processing routine are relatively simple, sometimes only the access state of the memory is to be analyzed. In such a situation, only the needed data trace information can be obtained with minimized stall of CPU 1.

It is to be noted that, the output signal of counter 33 may be used as the event A output signal, and the branch trace enable signal may be switched if the interrupt request from ICU 5 is made for a prescribed number of times, as the trace device in the third embodiment shown in FIG. 3.

As described above, according to the trace device in the eighth embodiment of the present invention, the mixed trace mode is changed to the data trace mode when the event corresponding to the prescribed cause of interrupt is generated. As a result, the operand access in the interrupt processing can be analyzed in detail, and the bug of the software can easily be found.

(Ninth embodiment)

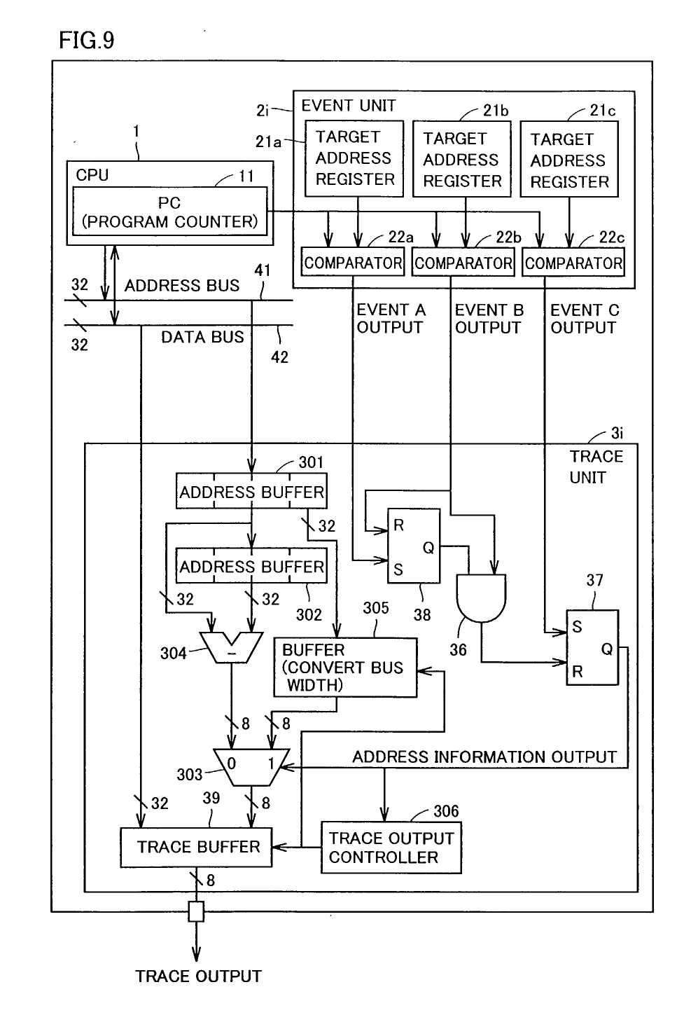

FIG. 9 is a block diagram showing a schematic structure of a semiconductor device having a trace device in a ninth embodiment of the present invention. The semiconductor device includes CPU 1, an event unit 2i and a trace unit 3i. Herein, portions having the same structure and function as the semiconductor devices in the first to eighth embodiments shown in FIGS. 1-8 are indicated by the same reference characters.

Event unit 2i includes target address registers 21a-21c wherein target addresses are set, comparator 22a to compare a value of PC 11 of CPU 1 with the target address held in target address register 21a, comparator 22b to compare the value of PC 11 of CPU 1 with the target address held in target address register 21b, and comparator 22c to compare the value of PC 11 of CPU 1 with the target address held in target address register 21c. Target address registers 21a-21c are accessible by CPU 1.

Comparator 22a compares the PC value of CPU 1 with the target address set in target address register 21a, and outputs the L level when they mismatch, and outputs the H level when they match to notify trace unit 3i of the generation of the event A. Similarly, comparator 22b compares the PC value of CPU 1 with the target address set in target address register 21b, and outputs the L level when they mismatch, and outputs the H level when they match to notify trace unit 3i of the generation of the event B. Similarly, comparator 22c compares the PC value of CPU 1 with the target address set in target address register 21c, and outputs the L level when they mismatch, and outputs the H level when they match to notify trace unit 3i of the generation of the event C.

Trace unit 3i includes AND gate 36, RS-FFs 37 and 38, trace buffer 39, address buffers 301 and 302 to hold addresses of 32 bits, a selector 303, a subtracter 304, a buffer 305 to convert an address having width of 32 bits to an address having width of 8 bits, and a trace output controller 306. It is assumed that, in the initial state, RS-FF 37 outputs the output signal of the H level, RS-FF 38 outputs the output signal of the L level, and an address information output signal is set to the H level.

Address buffer 301 holds the address of 32 bits that is being output to address bus 41 at present. Address buffer 302 holds the address of 32 bits that is being output to the address bus last time. Subtracter 304 subtracts the last address held in address buffer 302 from the present address held in address buffer 301, and outputs the result as a difference address of 8 bits to selector 303.

Buffer 305 for converting the bus width converts the present address of 32 bits held in address buffer 301 to four addresses of 8 bits, and successively outputs the result to selector 303.

If the address information output signal output from RS-FF 37 is at the H level, selector 303 selects and outputs the output signal of buffer 305. In addition, if the address information output signal output from RS-FF 37 is at the L level, selector 303 selects and outputs the output signal of subtracter 304.

Trace output controller 306 refers to the address information output signal output from RS-FF 37, decides whether the address output from selector 303 is the address with converted bus width or the subtracted address, and controls the packet output from trace buffer 39. If the address information output signal is at the H level, trace output controller 306 controls trace buffer 39 so as to generate the packet including four addresses of 8 bits. In such a situation, the trace information of 6 packets is generated and output, as described above.

If the address information output signal is at the L level, trace output controller 306 controls trace buffer 39 so as to generate the packet including the difference address of 8 bits. In such a situation, as the trace information of 3 packets is generated and output, the trace information can be reduced by 3 bytes.

Selector 303 can be made such that, when the address information signal is at the L level, it outputs only the lower 8 bits of the present address of 32 bits held in address buffer 301, rather than selecting the difference address output from subtracter 304.

As RS-FF 37 outputs the address information output signal of the H level in the initial state, selector 303 selects and outputs the address output from buffer 305 with converted bus width. As a result, the trace information including the address information of 32 bits is output from trace buffer 39.

When the PC value of CPU 1 matches the target address held in target address register 21a and the event A is generated, RS-FF 38 is set and the output signal of the H level is output. In this state, as the output signal of RS-FF 37 does not change, four addresses of 8 bits with converted bus widths are output to trace buffer 39.

Then, when the PC value of CPU 1 matches the target address held in target address register 21b and the event B is generated, RS-FF 37 is reset and the address information output signal is changed to the L level, whereby the difference address of 8 bits is output to trace buffer 39. In this state, as RS-FF 38 is reset and its output signal of the H level is output, RS-FF 37 will not be reset even if the event B is generated again.

Then, when the PC value of CPU 1 matches the target address held in target address register 21c and the event C is generated, RS-FF 37 is set and the address information output signal is set to the H level again, whereby four addresses of 8 bits with converted bus width are output to trace buffer 39.

As described above, according to the trace device in the ninth embodiment of the present invention, the trace information is generated by switching the address with converted bus width and the difference address when the PC value of CPU 1 matches any of the target addresses set in target address registers 21a-21c. As a result, the amount of the trace information is reduced even when the software is to be analyzed in detail, and the overflow of trace buffer 39 can be reduced. Therefore, the debugging of the software can be performed in a condition similar to that of the normal operation of CPU 1 even when the trace device is operating in the full trace mode.

In addition, the amount of trace information can be reduced at the debugging within the region where the upper 24 bits of the software are the same, if selector 303 is made to output only the lower 8 bits of the present address of 32 bits held in address buffer 301 when the address information output signal is at the L level.

When it is known that the upper 24 bits of the addresses generated in a certain subroutine are the same all the time, for example, the starting address of the subroutine is set in target address register 21b, and the last address of the subroutine is set in target address register 21c when the debugging of the subroutine is performed. Thus, the trace information can be generated with addresses of 8 bits when CPU 1 is executing the processing of the subroutine. Therefore, the debugging of the software can be performed in a condition similar to that of the normal operation of CPU 1, even when the trace device is operating in the full trace mode.

(Tenth embodiment)

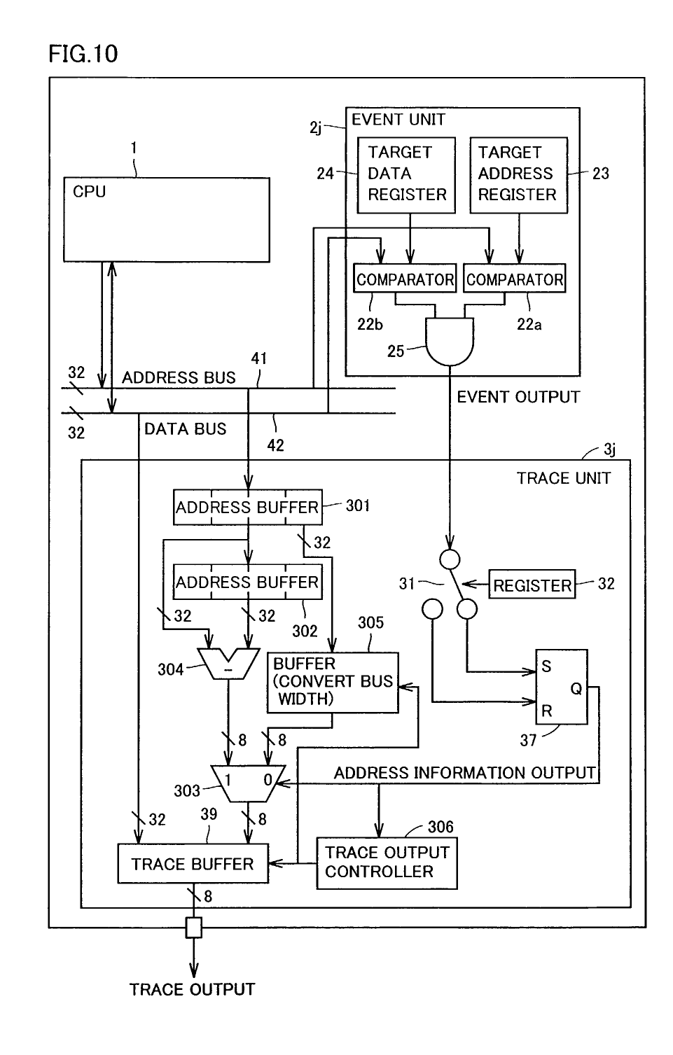

FIG. 10 is a block diagram showing a schematic structure of a semiconductor device having a trace device in a tenth embodiment of the present invention. The semiconductor device includes CPU 1, an event unit 2j and a trace unit 3j. Herein, portions having the same structure and function as the semiconductor devices in the first to ninth embodiments shown in FIGS. 1-9 are indicated by the same reference characters.

Event unit 2j includes target address register 23 wherein a target address is set, target data register 24 wherein target data are set, comparator 22a to compare the address value output to address bus 41 with the target address held in target address register 23, comparator 22b to compare the data output to data bus 42 with the target data held in target data register 24, and AND gate 25. Herein, target address register 23 and target data register 24 are accessible by CPU 1.

Comparator 22a compares the address value output to address bus 41 with the target address set in target address register 23, and outputs the L level when they mismatch, and outputs the H level when they match. Comparator 22b compares the data value output to data bus 42 with the target data set in target data register 24, and outputs the L level when they mismatch, and outputs the H level when they match.

When the output signals of both comparators 22a and 22b are at the H level, AND gate 25 outputs the H level to notify trace unit 3j of the generation of the event.

Trace unit 3j includes switch 31, register 32 wherein a value for switching switch 31 is set, RS-FF 37, trace buffer 39, address buffers 301 and 302 to hold addresses of 32 bits, selector 303, subtracter 304, buffer 305 to convert an address having width of 32 bits to an address having width of 8 bits, and trace output controller 306. It is assumed that RS-FF 37 outputs the output signal of the L level in the initial state.

When the address information output signal is at the L level, trace output controller 306 controls trace buffer 39 to generate the packet including four addresses of 8 bits. In such a situation, the trace information of 6 packets is generated and output as described above.

When the address information output signal is at the H level, trace output controller 306 controls trace buffer 39 to generate the packet including the difference address of 8 bits. In such a situation, the trace information can be reduced by 3 bytes because the trace information of 3 packets is generated and output. It is to be noted that, selector 303 may output only the lower 8 bits of the present address of 32 bits held in address buffer 301 rather than selecting the difference address output from subtracter 304, when the address information output signal is at the H level.

In the initial state, as RS-FF 37 outputs the address information output signal of the L level, selector 303 selects and outputs the address output from buffer 305 with converted bus width. As a result, the trace information including the address information of 32 bits is output from trace buffer 39.

When the address value output to address bus 41 matches the target address held in target address register 23, the data output to data bus 42 matches the target data held in target data register 24 and the event is generated, RS-FF 37 is set and the address information output signal of the H level is output. In this situation, the difference address of 8 bits is output to trace buffer 39.

As described above, according to the trace device in the tenth embodiment of the present invention, the trace information is generated by switching the address with converted bus width and the difference address when the address value output to address bus 41 matches the target address set in target address register 23 and the data output to data bus 42 matches the target data set in target data register 24. As a result, the amount of the trace information is reduced even when the software is to be analyzed in detail, and the overflow of trace buffer 39 can be reduced. Therefore, the debugging of the software can be performed in a condition similar to that of the normal operation of CPU 1 even when the trace device is operating in the full trace mode.

In addition, the amount of trace information can be reduced at the debugging within the region where the upper 24 bits of the software are the same, if selector 303 is made to output only the lower 8 bits of the present address of 32 bits held in address buffer 301 when the address information output signal is at the H level.

When CPU 1 accesses a certain data of a certain address, and when it is known that the upper 24 bits of the addresses of the operand accesses thereafter are the same, for example, the trace information can be generated by setting the certain address in target address register 23 and setting the certain data in target data register 24 to make the address of 8 bits at the operand access. Therefore, the debugging of the software can be performed in a condition similar to that of the normal operation of CPU 1 even when the trace device is operating in the full trace mode.

It is to be noted that, the output signal of counter 33 may be used as the event output signal and the address information output signal may be switched when the interrupt request from ICU 5 is made for a prescribed number of times, as the trace device in the third embodiment shown in FIG. 3. Alternatively, the output signal of AND gate 36a may be used as the event output signal and the address information output signal may be switched when the event B is generated after the event A, as the trace device in the fifth embodiment shown in FIG. 5. Furthermore, the interrupt request signal output from ICU 5 may be used as the event output signal, and the address information output signal may be switched when the interrupt request from ICU 5 is made, as the trace device in the eighth embodiment shown in FIG. 8.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A trace device to generate trace information by switching between a full trace mode to generate trace information while stalling a processor, and a real-time trace mode to generate trace information while not stalling said processor, comprising:
an event unit generating an event when a predetermined condition is met; and
a trace unit detecting generation of said event and generating trace information by switching between said full trace mode and said real-time trace mode.

2. The trace device according to claim 1, wherein
said trace unit includes a register storing information indicating whether a trace mode is switched from the full trace mode to the real-time trace mode, or from the real-time trace mode to the full trace mode, when the event is generated.

3. The trace device according to claim 1, wherein
said trace unit includes a register holding information indicating whether a trace mode is said full trace mode or said real-time trace mode and outputting said information to the outside.

4. The trace device according to claim 1, wherein
said event unit includes
a target address register wherein a target address is set, and
a comparator generating the event when a value of a program 5 counter of said processor matches the target address set in said target address register.

5. The trace device according to claim 1, wherein
said event unit includes
a target address register wherein a target address is set, and
a comparator generating the event when an address in an operand access of said processor matches the target address set in said target address register.

6. The trace device according to claim 1, wherein
said event unit includes
a target data register wherein target data are set, and
a comparator generating the event when operand access data of said processor matches the target data set in said target data register.

7. The trace device according to claim 1, wherein
said event unit includes
a target address register wherein a target address is set,
a target data register wherein target data are set,
a first comparator detecting a matching of an address value output to an address bus with the target address set in said target address register,
a second comparator detecting a matching of data output to a data bus with the target data set in said target data register, and
a logic circuit generating the event when said first comparator detects the matching and said second comparator detects the matching.

8. The trace device according to claim 1, wherein
said event unit includes an interrupt control unit detecting a cause of an interrupt, outputting an interrupt request to said processor, and generating the event.

9. The trace device according to claim 1, wherein
said event unit includes
an interrupt control unit detecting a cause of an interrupt and outputting an interrupt request to said processor, and
a counter generating the event when the interrupt request from said interrupt control unit is made for a prescribed number of times.

10. The trace device according to claim 1, wherein
said event unit includes a timer generating the event when a predetermined time period has passed.

11. The trace device according to claim 1, wherein
said event unit includes
a first target address register wherein a first target address is set,
a second target address register wherein a second target address is set,
a first comparator detecting a matching of a value of a program counter of said processor with the first target address set in said first target address register,
a second comparator detecting a matching of a value of a program counter of said processor with the second target address set in said second target address register, and
a logic circuit generating the event when said first comparator detects the matching and then said second comparator detects the matching.

12. A trace device to generate trace information of a processor by switching a trace mode to one of a branch trace mode, a data trace mode and a mixed trace mode, comprising:
an event unit generating an event when a predetermined condition is met; and
a trace unit detecting a generation of said event and generating trace information by switching to one of said branch trace mode, said data trace mode and said mixed trace mode.

13. The trace device according to claim 12, wherein
said trace unit includes a register storing information indicating which of the branch trace mode, data trace mode and mixed trace mode a trace mode is switched when the event is generated.

14. A trace device to generate and output trace information of a processor, comprising:
an event unit generating an event when a predetermined condition is met; and
a trace unit detecting a generation of said event and generating trace information after determining whether to generate the trace information in an absolute address or in a relative address.

15. The trace device according to claim 14, wherein
said trace unit includes a register storing information indicating whether a mode of generating trace information in the absolute address is switched to a mode of generating trace information in the relative address, or a mode of generating trace information in the relative address is switched to a mode of generating trace information in the absolute address, when the event is generated.

16. The trace device according to claim 14, wherein
said trace unit includes
a first address register holding a present address,
a second address register holding the last address,
a subtracter subtracting the last address held in said second address register from the present address held in said first address register,
a selector detecting the generation of said event, selecting the address held in said first address register or the address subtracted by said subtracter, and outputting the result as trace information, and
a trace buffer generating and outputting a packet including the trace information output from said selector.

17. The trace device according to claim 14, wherein
said trace unit includes
an address register holding an address,
a selector detecting the generation of said event, selecting the address held in said address register or predetermined lower bits of the address held in said address register, and outputting the result as trace information, and
a trace buffer generating and outputting a packet including the trace information output from said selector.
